(19) United States
(12) Patent Application Publication
(10) Pub. No.: US 2026/0022754 A1
(43) Pub. Date: Jan. 22, 2026

(54) DAMPING APPARATUS

(71) Applicant: TILTA INC., Burbank, CA (US)

(72) Inventors: Long MA, Shenzhen (CN); Yaolong LUO, Shenzhen (CN); Wenping ZENG, Shenzhen (CN); Kefeng ZHOU, Shenzhen (CN)

(21) Appl. No.: 19/269,912

(22) Filed: Jul. 15, 2025

(30) Foreign Application Priority Data
Jul. 19, 2024 (CN) 2024217279976

(51) Int. Cl. F16F 9/56; F16F 9/32; F16M 13/02

(52) U.S. Cl. CPC F16F 9/56; F16F 9/3207; F16M 13/022; F16F 2230/0041; F16F 2238/026

(57) ABSTRACT

A damping apparatus, including a damping main arm, a base, a buffer assembly, and a coupling assembly. The front end of the damping main arm is designed to support and carry camera equipment. The base is rotatably connected to the rear end of the damping main arm. The buffer assembly is rotatably connected to the front end of the damping main arm and is configured to provide load damping. The coupling assembly includes a first connector, which is movably connected to the base, and a second connector, which is movably connected to the damping main arm. The coupling assembly forms a buffer zone among the damping main arm, the base, and the buffer assembly. When the damping apparatus pitches, the first and the second connectors swing slightly, thereby reducing variations in the movement stroke of the buffer assembly.

### CROSS-REFERENCE TO RELATED APPLICATIONS

The present application for patent claims priority to and the benefit of pending Chinese Application No. 2024217279976, filed on Jul. 19, 2024, and hereby expressly incorporated by reference herein as if fully set forth below in its entirety and for all applicable purposes.

### TECHNICAL FIELD

The present disclosure pertains to the technical field of camera stabilization devices, specifically to a damping apparatus.

### INTRODUCTION

Currently, in mobile shooting scenarios, both indoors and outdoors, shock-absorbing apparatuses are commonly employed to stabilize camera equipment during filming. The camera equipment is mounted on the damping apparatus, which is fixed to a moving vehicle to ensure smooth footage.

In existing solutions, when shooting dynamic scenes with moving cameras indoors or outdoors, spring-based damping mechanisms are typically used as energy-absorbing buffers to stabilize the video camera during filming. These mechanisms leverage the elasticity and compressible/expandable stroke characteristics of springs to absorb shocks.

Conventional spring-based damping arms serve as buffer assemblies, with camera equipment mounted on the damping mechanisms. However, due to road surface influences, when the camera equipment pitches, significant stroke variations in the buffer assembly lead to greater instability in the camera load, resulting in less stable footage.

### BRIEF SUMMARY

The present disclosure provides a damping apparatus that reduces stroke variations in a buffer assembly of the damping apparatus, thereby improving shooting stability.

Aspects of the present disclosure provide a damping apparatus, including:
a damping main arm, wherein the front end of the damping main arm is configured to carry imaging equipment;
a base rotatably connected to the rear end of the damping main arm;
a buffer assembly rotatably connected to the front end of the damping main arm and configured to provide load damping for the imaging equipment; and
a coupling assembly configured to connect the damping main arm, the base, and the buffer assembly, wherein the coupling assembly includes a first connector movably connected to the base and a second connector movably connected to the damping main arm;
wherein the end of the first connector opposite to the base is movably connected to the second connector, the second connector is movably connected to the free end of the buffer assembly, the rotation axes on the damping main arm, the first connector, and the second connector are arranged in parallel, and the coupling assembly forms a buffer zone among the damping main arm, the base, and the buffer assembly to reduce variations in the movement stroke of the buffer assembly.

### BRIEF DESCRIPTION OF THE DRAWINGS

FIG. 1 is a diagram illustrating a damping apparatus according to some aspects of the disclosure;

FIG. 2 is a diagram illustrating a damping main arm according to some aspects of the disclosure;

FIG. 3 is a diagram illustrating a second connector according to some aspects of the disclosure;

FIG. 4a is a diagram illustrating a buffer assembly stroke in the prior art;

FIG. 4b is a diagram illustrating a buffer assembly stroke according to the present disclosure;

FIG. 5 is a diagram illustrating the second connector according to some aspects of the disclosure;

FIG. 6 is a diagram illustrating a support assembly according to some aspects of the disclosure;

FIG. 7 is a diagram illustrating a locking member according to some aspects of the disclosure.

Reference Numerals: 1—damping main arm; 11—damping head; 2—base; 3—buffer assembly; 31—elastic element; 32—damper unit; 33—force adjuster; 34—baffle ring; 4—coupling assembly; 41—first connector; 42—second connector; 421—connection body; 422—connection position; 423—connecting rod; 43—adjustment unit; 431—adjustment screw; 432—adjustment knob; 433—adjustment link; 44—joint section; 5—support assembly; 51—strut member; 52—locating element; 521—electric suction cup; 522—damping connection frame; 523—vehicle connection frame; 53—locking member; 531—sliding block; 532—clamping jaw; 533—locking lever.

### DETAILED DESCRIPTION

When shooting dynamic scenes with moving cameras indoors or outdoors, damping devices for imaging equipment are typically used to ensure stable and smooth footage. Conventional damping apparatuses generally employ spring-based mechanisms as energy-absorbing buffers, utilizing the elasticity and stroke variation characteristics of springs for shock absorption.

In conventional spring-based damping arms serving as buffer assemblies, the filming equipment is mounted on the damping mechanism for use. Due to road surface influences, during the pitching motion of the camera equipment, significant stroke variations in the buffer assembly result in correspondingly larger displacements of the carried filming equipment, thereby compromising shooting stability. Moreover, excessive spring stroke easily leads to metal fatigue, and the damping force and rebound speed cannot be quickly adjusted according to the camera's weight. When the damping device needs to accommodate equipment of different weights, replacing the springs is typically required, which is highly inconvenient.

The present disclosure provides a damping apparatus that establishes a buffer zone among a damping main arm 1, a base 2, and a buffer assembly 3. Through the motion of the linkage mechanism, variations in the movement stroke of the buffer assembly 3 are absorbed, reducing the amplitude of the carried filming equipment and improving shooting stability.

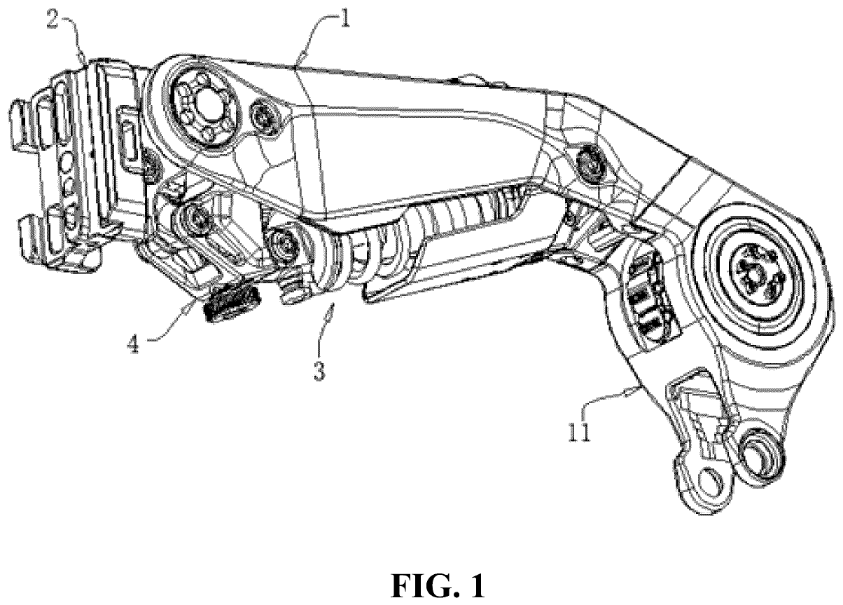

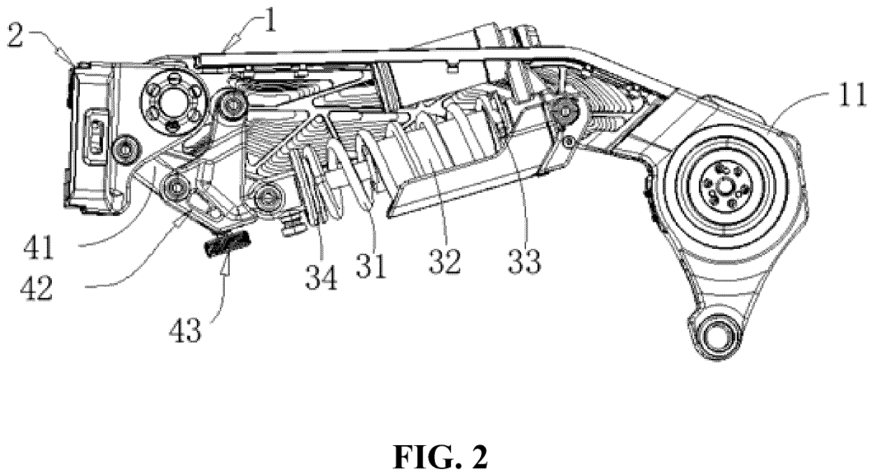

In some aspects, referring to FIGS. 1 and 2, the damping apparatus includes: a damping main arm 1, wherein the front end of the damping main arm 1 is configured to carry camera equipment; a base 2, rotatably connected to the rear end of the damping main arm 1; a buffer assembly 3, rotatably connected to the front end of the damping main arm 1 and configured to provide load damping; and a coupling assembly 4, configured to connect the damping main arm 1, the base 2, and the buffer assembly 3 and form a buffer zone.

In some aspects, the coupling assembly 4 includes: a first connector 41 movably connected to the base 2; and a second connector 42 movably connected to the damping main arm 1. The end of the first connector 41 opposite to the base 2 is movably connected to the second connector 42, and the second connector 42 is movably connected to the free end of the buffer assembly 3. The coupling assembly 4 forms a buffer zone among the damping main arm 1, the base 2, and the buffer assembly 3 to reduce variations in the movement stroke (or travel distance) of the buffer assembly 3.

In some aspects, the damping main arm 1, the base 2, and the buffer assembly 3 are movably interconnected via the first connector 41 and the second connector 42. Each movable connection can be achieved through rotation shafts, with the rotation shafts on the damping main arm 1, the first connector 41, and the second connector 42 arranged in parallel. This configuration forms a damping-enabled coupling assembly 4 among the damping main arm 1, the base 2, and the buffer assembly 3. The coupling assembly 4, through the first connector 41, the second connector 42, the damping main arm 1, and the base 2, functions similarly to a linkage-based buffer mechanism. Thus, when road conditions induce a pitching tendency in the damping main arm 1, the movable connections of the first connector 41 and the second connector 42 enable them to swing accordingly, reducing and absorbing variations in the movement stroke of the buffer assembly 3. As a result, the vertical amplitude (e.g., up-down movement or vibration) of the carried filming equipment is minimized, enhancing the stability of the filming equipment while shooting.

Referring to FIG. 1, the front end of the damping main arm 1 includes a damping head 11 for mounting camera accessories equipped with camera equipment. The damping head 11 can accommodate camera devices, typically including filming cameras fitted with accessories such as stabilizers or full cages for protection and functional expansion, providing additional mounting space and power supply systems. The front end of the damping main arm 1 collectively supports the camera equipment load.

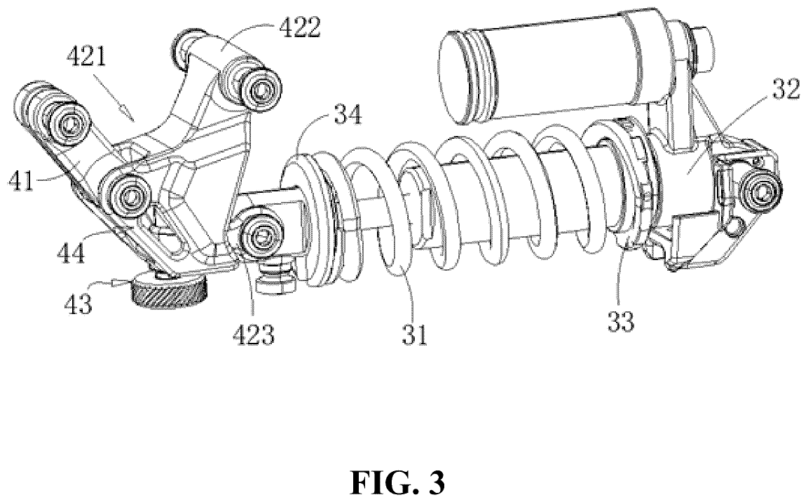

Referring to FIGS. 2 and 3, the second connector 42 includes a connection body 421 and a connecting rod 423. One end of the connecting rod 423 is attached to the connection body 421, while the other end is rotatably connected to the free end of the buffer assembly 3. Both ends of the first connector 41 and the connecting rod 423 are designed to be movable. The connection body 421 serves to buffer forces through its interaction with the first connector 41 and the connecting rod 423, while the load being carried can be damped by both the buffer assembly 3 and the movable coupling assembly 4. This setup minimizes variations in the movement stroke or travel of the buffer assembly 3, thereby reducing the amplitude (e.g., up-down movement) of the filming equipment and enhancing filming stability. The free end of the buffer assembly 3 can be flexibly connected to the connection body 421 via the connecting rod 423, improving overall adaptability.

Referring to FIG. 3, the second connector 42 can feature a connection position 422 (a connection portion) on the connection body 421. In some aspects, the connection body 421 is generally triangular in shape, with the connection position 422 (connected to the damping main arm 1) located at one corner and extended to enhance the adjustable range of the connection body 421.

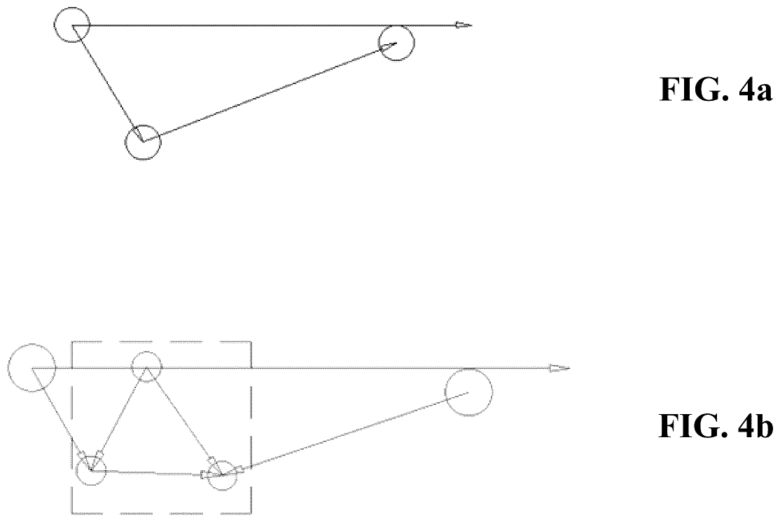

Referring to FIGS. 4a and 4b, when the damping main arm 1 pitches, the movable configuration of the first connector 41, the second connector 42, and the connecting rod 423 enables the first connector 41 and the second connector 42 to swing slightly, absorbing variations in the movement stroke of the buffer assembly 3.

For instance, in FIG. 4b, when road conditions cause the damping main arm 1 to tilt upward, the buffer assembly 3 undergoes corresponding deformation. The area within the left dashed box in FIG. 4b pivots around the connection point between the second connector 42 and the damping main arm 1, swinging toward the buffer assembly 3 rightward as viewed in FIG. 4b, thereby reducing the displacement of the buffer assembly 3. Conversely, when road conditions cause the damping main arm 1 to tilt downward, the buffer assembly 3 also deforms accordingly. The area within the left dashed box pivots away from the buffer assembly 3 leftward as viewed in FIG. 4b, similarly reducing the displacement of the buffer assembly 3.

Referring to FIG. 3, the connection body 421 includes a joint section 44 and an adjustment unit 43. Rotation of the adjustment unit 43 drives the connecting rod 423 to move, adjusting the angle between the buffer assembly 3 and the damping main arm 1. In some aspects, the first connector 41 is configured as a linkage structure and rotatably mounted at another corner of the connection body 421. Furthermore, the adjustment unit 43 is positioned at the remaining corner of the second connector 42, with the connecting rod 423 mounted on the adjustment unit 43. Rotation of the adjustment unit 43 adjusts the position of the connecting rod 423 and the buffer assembly 3 on the second connector 42, thereby modifying the angle between the buffer assembly 3 and the damping main arm 1. In some aspects, the damping main arm 1, the base 2, and the buffer assembly 3 are movably connected to the three corners of the connection body 421, respectively. The motion of the connection body 421 within the buffer zone further dampens forces applied to the buffer assembly 3, reducing its stroke variation or travel.

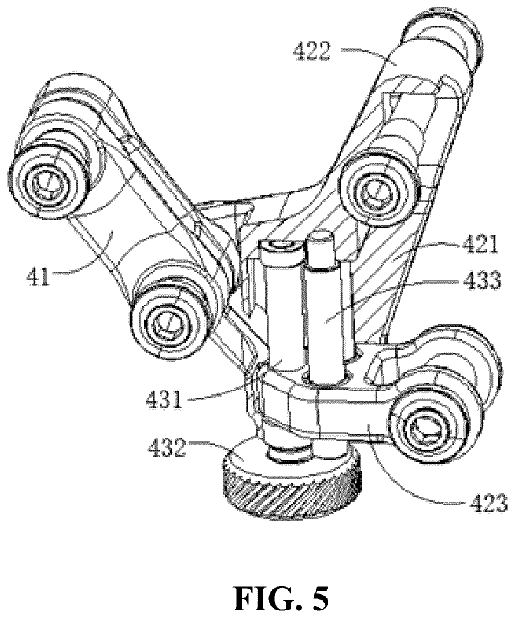

In some aspects, referring to FIG. 5, the adjustment unit 43 includes an adjustment screw 431, an adjustment knob 432, and at least one adjustment link 433. The joint section 44 is hollow and includes an opening for the adjustment screw 431 to pass through. The front end of the adjustment screw 431 extends into the joint section 44 and is rotatably connected to it. An inner groove within the joint section 44 houses a bearing, which is fitted around the front end of the adjustment screw 431, enabling its rotatable connection with the joint section 44. A support seat is installed at the opening, with its outer thread engaging the opening and its inner bore allowing the adjustment screw 431 to pass through. An annular washer fixed to the adjustment screw 431 near its rear end rests between the bearing and the support seat (supporting the washer), preventing the adjustment screw 431 from disengaging. The rear end of the adjustment screw 431 serves as an adjustment terminal outside the joint section 44, with the adjustment knob 432 fixed to it in circumferential alignment. The connecting rod 423 is threaded onto the adjustment screw 431, whose rotation adjusts the position of the connecting rod 423 and the attached buffer assembly 3 along the screw's length direction, facilitating external control. The axis of the adjustment screw 431 is perpendicular to that of the rotation shafts on the second connector 42, allowing adjustment of the position of the buffer assembly 3 on the connection body 421 to alter the load-bearing point and accommodate heavier filming equipment.

Referring to FIG. 5, the adjustment links 433 are parallel to the adjustment screw 431. In some aspects, two adjustment links 433 are provided, mounted on the joint section 44. The connecting rod 423 is formed with openings to allow the adjustment links 433 to pass through, enabling a sliding connection between the adjustment links 433 and the connecting rod 423. This arrangement guides the movement of the connecting rod 423 and enhances connection stability.

Referring to FIG. 2, rotating the adjustment knob 432 drives the connecting rod 423 and the buffer assembly 3 to move along the axis of the adjustment screw 431, thereby altering the relative angle between the buffer assembly 3 and the damping main arm 1. A larger angle increases the upward force component, enabling the damping apparatus to support heavier filming equipment.

Referring to FIG. 2, the buffer assembly 3 includes an elastic element 31 and a damper unit 32. In some aspects, the elastic element 31 is a damping spring, and the damper unit 32 is a damper (e.g., shock absorber). A fixed end of the damper is rotatably connected to the front end of the damping main arm 1, while a free end (i.e., the piston rod end of the damper) is rotatably mounted on the second connector 42. The damping spring can be sleeved over the damper, and the elastic element 31 extends or compresses as the damper unit 32 expands or contracts, thereby achieving shock absorption.

Further referring to FIG. 2, a force adjuster 33 is sleeved on the damper unit 32 and adjustably mounted on the damper. A baffle ring 34 is provided at the end of the damper near the second connector 42. One end of the damping spring abuts or is directly connected to the baffle ring 34, while the other end abuts or is directly connected to the force adjuster 33. By adjusting the position of the force adjuster 33 on the damper, the length of the damping spring can be controlled, thereby modifying the deformation (e.g., initial compression) of the elastic element 31. This enables the damping apparatus to accommodate filming equipment of varying weights, enabling quick adjustment of damping force and rebound speed based on the camera's weight without requiring spring replacement, thus improving adaptability.

In some aspects, the force adjuster 33 is threadedly connected to the damper, with its movement direction aligned along the length of the damper's piston rod. The optimal position of the force adjuster 33 can be determined through testing based on the actual load of the filming equipment during use.

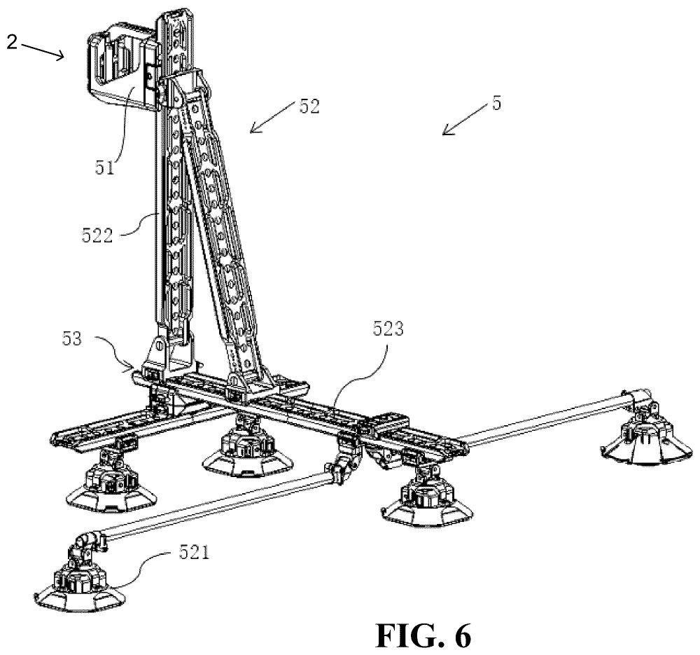

In some aspects, referring to FIG. 6, a support assembly 5 is provided on the side of the base 2 opposite to the damping main arm 1. The support assembly 5 includes: a strut member 51 for connecting to the base 2 and supporting the damping apparatus; a locating element 52 for fixing to a vehicle; and a locking member 53, wherein the strut member 51 is adjustably mounted on the locating element 52 via the locking member 53.

In some aspects, referring to FIG. 6, the locating element 52 includes a damping connection frame 522, a vehicle connection frame 523, and multiple electric suction cups 521. The strut member 51 is designed as a frame structure and is fastened to the damping connection frame 522 via the locking member 53. The damping connection frame 522 is equipped with multiple interfaces for connecting to the strut member 51, enabling adjustment of the damping apparatus' mounting position. The damping connection frame 522 and the vehicle connection frame 523 can be unlocked, adjusted, and then relocked using the locking member 53. The electric suction cups 521 are connected to both the damping connection frame 522 and the vehicle connection frame 523 through the locking member 53.

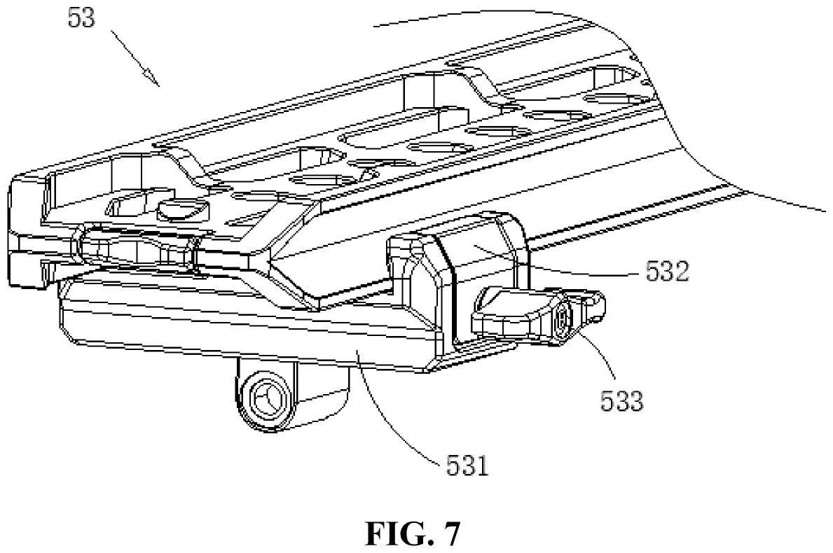

In some aspects, referring to FIGS. 6 and 7, the locking member 53 includes a sliding block 531, clamping jaws 532, and a locking lever 533. The sliding block 531 is located at the end of the damping connection frame 522, allowing the damping connection frame 522 to engage and slide along the vehicle connection frame 523. Clamping jaws 532 are distributed on both sides of the vehicle connection frame 523 and slidably mounted on the sliding block 531. The locking lever 533 is provided on the sliding block 531 and is configured to drive the clamping jaws 532 towards the vehicle connection frame 523 until they securely clamp it, thereby ensuring a stable connection between the vehicle connection frame 523 and the damping connection frame 522. In some aspects, the sliding block 531 is designed as a sliding plate with side flanges that hook onto the vehicle connection frame 523. The clamping jaws 532 are sliding plates mounted on the flanges. The locking lever 533 can be a screw rotatably mounted on the sliding block 531 and threadedly connected to the clamping jaws 532. Rotating the screw adjusts the position of the clamping jaws 532 to firmly clamp the vehicle connection frame 523. Alternative removably connected locking structures may be utilized in other examples. The electric suction cups 521 are positioned and numbered according to the vehicle's surface profile. Their upper ends are secured to the damping connection frame 522 and vehicle connection frame 523 through the locking member 53, and their lower ends are adsorbed to the vehicle surface. Similarly, the strut member 51 can be locked to the damping connection frame 522 using the same locking principle, which is not detailed here.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

What is claimed is:

1. A damping apparatus, comprising:
a damping main arm, wherein a front end of the damping main arm is configured for carrying camera equipment;
a base rotatably connected to a rear end of the damping main arm;
a buffer assembly rotatably connected to the front end of the damping main arm, wherein the buffer assembly is configured to provide load damping for the camera equipment; and
a coupling assembly configured to connect the damping main arm, the base, and the buffer assembly, wherein the coupling assembly comprises a first connector movably connected to the base and a second connector movably connected to the damping main arm; and
wherein an end of the first connector opposite to the base is movably connected to the second connector,
wherein the second connector is movably connected to a free end of the buffer assembly, and
wherein the coupling assembly forms a buffer zone among the damping main arm, the base, and the buffer assembly to reduce variation in a movement stroke of the buffer assembly.

2. The damping apparatus according to claim 1, wherein the second connector comprises a connection body and a connection position provided on the connection body, the connection position is configured to connect to the damping main arm, and the connection position is extended to increase an adjustable range of the connection body.

3. The damping apparatus according to claim 1, wherein the second connector comprises a connection body and a connecting rod; and
wherein one end of the connecting rod is connected to the connection body, and another end of the connecting rod is rotatably connected to the free end of the buffer assembly.

4. The damping apparatus according to claim 3, wherein the connection body comprises a joint section and an adjustment unit, and a rotation of the adjustment unit is configured to drive the connecting rod to adjust an angle between the buffer assembly and the damping main arm.

5. The damping apparatus according to claim 4, wherein the adjustment unit comprises an adjustment screw;
wherein one end of the adjustment screw is rotatably connected to the joint section and another end of the adjustment screw is configured as an adjustment end and positioned outside the joint section; and
wherein the connecting rod is threadedly connected to the adjustment screw, and a rotation of the adjustment screw adjusts a movement of the connecting rod along a length direction of the adjustment screw.

6. The damping apparatus according to claim 5, wherein the adjustment unit further comprises at least one adjustment link;
wherein the adjustment link is provided on the joint section, and the connecting rod is provided with an opening configured to enable the adjustment link to pass through and movably connect with the connecting rod.

7. The damping apparatus according to claim 1, wherein the buffer assembly comprises an elastic element and a damper unit;
wherein a fixed end of the damper unit is rotatably connected to the damping main arm; and
wherein a free end of the damper unit is rotatably provided on the second connector, the elastic element is provided on the damper unit, and the elastic element extends as the damper unit expands or compresses as the damper unit contracts.

8. The damping apparatus according to claim 7, wherein the damper unit is further provided with a force adjuster;
wherein the force adjuster is adjustably provided on the damper unit; and
wherein one end of the elastic element is fixed relative to the damper unit, and another end of the elastic element is connected to the force adjuster to adjust deformation of the elastic element.

9. The damping apparatus according to claim 1, wherein a side of the base opposite to the damping main arm is provided with a support assembly;
wherein the support assembly comprises a strut member, a locating element, and a locking member; and
wherein the strut member is configured to connect to the base and support the damping apparatus, the strut member is adjustably provided on the locating element via the locking member, and the locating element is configured to be fixed to a vehicle.

10. The damping apparatus according to claim 9, wherein the locating element comprises an electric suction cup; and
wherein the electric suction cup is configured to adhere to a surface of the vehicle.
